(19) United States
(12) Patent Application Publication
(10) Pub. No.: US 2008/0296466 A1
(43) Pub. Date: Dec. 4, 2008

(54) APPARATUS FOR HOLDING A PERSONAL ARTICLE

(76) Inventor: Marlene Alfin, West Hartford, CT (US)

Correspondence Address: CANTOR COLBURN, LLP, 20 Church Street, 22nd Floor, Hartford, CT, 06103, US

(21) Appl. No.: 11/945,627

(22) Filed: Nov. 27, 2007

Related U.S. Application Data
(60) Provisional application No. 60/867,220, filed on Nov. 27, 2006.

(51) Int. Cl. F16M 13/00; F16B 45/00

(52) U.S. Cl. 248/542; 248/551; 248/308; 248/304; 248/339

(57) ABSTRACT

An apparatus suspending a personal article from an upper surface of a fixture is provided. The apparatus includes a vertical member, a first arm extending from a first end of the vertical member and resting on the upper surface of the fixture and a second arm extending from a second end of the vertical member from which the personal article hangs. The first arm includes a light source and the second arm includes a utility space storing personal items.

### CROSS REFERENCE TO RELATED APPLICATION

This application is a nonprovisional application of, and claims the benefit of, U.S. Provisional Application Ser. No. 60/867,220 filed on Nov. 27, 2006, the entire contents of which are incorporated herein by reference in their entirety.

### BACKGROUND OF THE INVENTION

1. Field of the Invention

The present invention relates to a personal article holder. More particularly, the present invention relates to a handbag or purse holder including a light and facilitating easy and convenient storage of the handbag or purse at a table, such as when dining out.

2. Description of the Related Art

An indispensable accessory carried by millions of people is a purse or handbag. The purse or handbag can be manufactured from a variety of materials such as leather, straw, canvas or silk and are designed to efficiently store personal belongings. Manufactured in a variety of sizes, colors and styles, all intended to appeal to the individual needs of the consumer, handbags are used for everything from carrying an extra tube of lipstick to carrying wallets, cellular telephones, important papers and even extra clothing. Regardless of whether one is clutching a fancy beaded evening bag, a practical and stylish midsize purse, or a bulky oversized tote, for most people, especially women, a purse or handbag is a necessity.

Although handbags are an indispensable accessory, they also present a problem when visiting public places such as restaurants or nightclubs. Often in such places, there is not enough room at a table or bar to place the handbag and the owner much instead place it on the floor or on top of the table. When placed on the floor or on top of the table, the handbag takes up a relatively great deal of valuable space, leaving little room for one's feet, or in the case of table top storage, for one's meal.

Another way a handbag may be stored when dining out includes hanging the handbag over the back of one's chair. However, this manner of storing the handbag creates an obstacle for servers. Additionally, the handbag may be easily bumped and knocked off the chair by other restaurant patrons, making a handbag hung on the back of a chair a nuisance. Most importantly, handbags or purses that are hidden under tables or left dangling from the back of chairs can be inadvertently left behind, or in a worst case scenario, can be easily stolen. A lost or stolen purse or handbag can be devastating, as valuable personal belongings such as identification, keys, licenses, money and other items are often stored in the confines of the purse or handbag.

Additionally, restaurants may be dimly lit to create privacy or an intimate ambience, making it difficult to read menus at the table or bar. A convenient light source to assist one in reading menus, a bill or check and the like, such as being incorporated into the handbag or purse holder would also improve the overall dining experience.

Therefore, a product that facilitates easy and convenient storage of purses and handbags when dining out is desired. Specifically, a personal article holder is desired having a compact and mobile design, including a light for allowing easier viewing and reading of items such as menus and including an alarm for notifying a user when the holder and/or the personal article has been moved.

### BRIEF SUMMARY OF THE INVENTION

An exemplary embodiment provides an apparatus for holding a personal article. The apparatus includes a vertical member, a first arm extending from a first end of the vertical member and resting on an upper surface of a fixture, and a second arm extending from a second end of the vertical member from which the personal article hangs. The first arm includes a light source and the second arm includes a utility space storing personal items.

An exemplary embodiment provides an apparatus for holding a personal article. The apparatus includes a vertical member, a first member extending substantially horizontally from the vertical member and resting on a top surface of a fixture and a second member extending substantially horizontally from the vertical member and from which the personal article hangs. The first member includes a light generating part. The second member includes a storage space in which personal items are stored. The second member is longer than the first member.

An exemplary embodiment provides an apparatus for holding a personal article. The apparatus includes a vertical member, an upper arm member extending substantially horizontally from the vertical member and resting on an upper surface of a fixture, a lower arm extending substantially horizontally from the vertical member and from which the personal article hangs and an alarm activated in response to movement detected with respect to the apparatus. The upper arm includes a light generating part. The lower arm is longer than the upper arm and includes a storage space in which personal items are stored. The movement activating the alarm includes removal of the personal article from the lower arm, removal of the personal items from the storage space and/or removal of the apparatus from the fixture.

### BRIEF DESCRIPTION OF THE DRAWINGS

The above and other advantages of the present invention will become readily apparent by reference to the following detailed description when considered in conjunction with the accompanying drawings wherein:

FIGS. 1 and 2 are side views of an exemplary embodiment of an apparatus according to the present invention;

FIG. 3 illustrates an exemplary embodiment of the apparatus being used to suspend a personal article from a fixture;

FIG. 4 illustrates an exemplary embodiment of the apparatus being used to view an object;

FIG. 5 is an exemplary embodiment showing dimensions of the apparatus;

FIGS. 6-9 illustrate front, back, top and bottom views, respectively of the apparatus;

FIG. 10 is a side view of another exemplary embodiment of an apparatus according to the present invention;

FIG. 11 is a top view of the apparatus being used to direct light to a desired position;

FIG. 12 is a side view of another exemplary embodiment of an apparatus according the present invention holding a personal article;

FIG. 13 is a side view of another exemplary embodiment of an apparatus according to the present invention including an angled lower arm holding a personal article; and

FIG. 14 is a side view of another exemplary embodiment of an apparatus according to the present invention including a protruding portion on the first and second covers.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout. As used herein, the term “and/or” includes any and all combinations of one or more of the associated listed items.

It will be understood that, although the terms first, second, third, etc., may be used herein to describe various elements, components, regions and/or sections, these elements, components, regions, layers and/or sections should not be limited by these terms. These terms are only used to distinguish one element, component, region or section from another region, layer or section. Thus, a first element, component, region, layer or section discussed below could be termed a second element, component, region or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The apparatus is designed to hold personal articles such as purses, handbags, shopping bags, briefcases, caps, coats and other handled (e.g., including a strap or loop for hanging) items, neatly and efficiently from an upper surface of a table, counter, door or the like. The holder has a “C” or “U” shape including a vertical member and at least two horizontal members.

An upper (horizontal) extension of the holder may have a flat, oval, circular or square cross-sectional profile and provide an anchor that would counteract a downward pull of the personal article being held by the holder while effectively preventing the unit from shifting or becoming dislodged from the table.

A lower (horizontal) extension of the holder is configured to extend from the vertical member to under the table. In this manner, when positioned in place at the table edge, the apparatus includes portions that extend downward from the upper surface of the table and under the table. The lower extension includes a space for storing or securing personal items, such as money, keys, lipstick/gloss, pepper spray and the like.

The apparatus includes a light positioned at or in the upper extension providing a readily available light source for use in easily reading items such as menus, a check, etc., in dimly lit or darkened areas, such as restaurants, cinemas, theatres, etc., and as well as locating objects such as car keys, a cosmetic or other personal items within the purse or handbag. The light may be activated by an on/off switch mounted in the apparatus, such as at an exterior location, or by rotating a cap on an end of the upper extension. The light may be pivotally connected to the vertical member enabling the user to swivel the light in a desired direction, including when the handbag is hanging from the table.

The apparatus may include safety or security features, such as an alarm, providing an audible or visual alert should the user's handbag be moved or removed from the table. The alarm may be pressure activated for automatic activation or may be manually activated providing a safety tool for those dining or traveling alone.

Hereinafter, the present invention will be explained in detail with reference to the accompanying drawings.

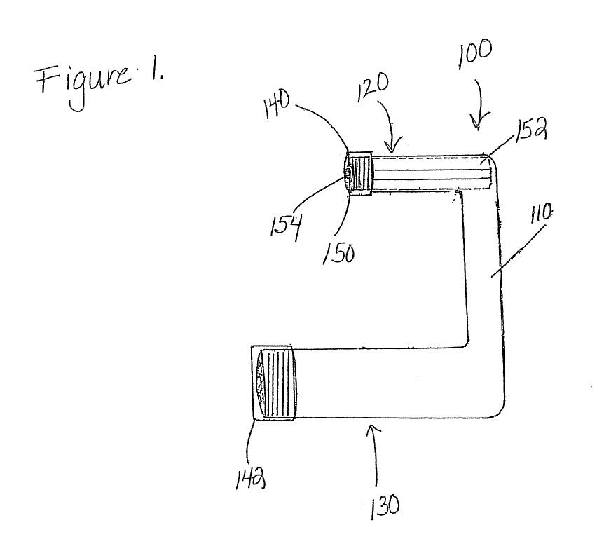

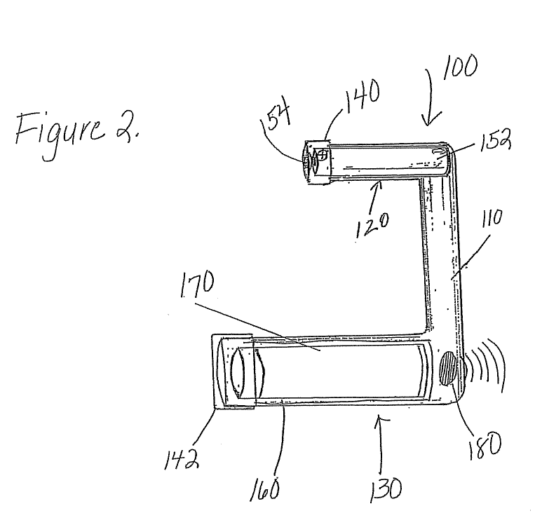

FIGS. 1 and 2 are side views of an exemplary embodiment of an apparatus according to the present invention.

The apparatus 100 includes a vertical member 110, a first arm 120 extending substantially horizontally from an upper end of the vertical member 110 and a second arm 130 extending substantially horizontally from a lower end of the vertical member 110. The first arm 120 would be placed on an upper surface of a fixture, such as a table, counter, door, etc. A personal article or belonging would be suspended or hung on the second arm 130. In exemplary embodiments, the second arm 130 may include an angled portion and/or a hook-like portion from which the personal article may hang.

The apparatus 100 is substantially “C” or “U” shaped and may be configured as a single continuous unit. The vertical member 110, the first arm 120 and/or the second arm 130 may have a flat, oval, circular or square cross-sectional profile, but is not limited thereto. The exterior surface of the apparatus 100 may be smooth, chamfered or have a textured finish. The apparatus 100 may be (continuously) hollow throughout the vertical member 110, the first arm 120 and the second arm 130. The first arm 120 includes a light source 150. The second arm 130 includes a utility space 160 within the second arm 130 for storing a personal item 170.

The vertical member 110 may be a single piece or may include multiple sections. In one exemplary embodiment, each of the multiple sections may be hollow and of different diameters such that one section is slidably connected to another section. To accommodate different thicknesses of fixtures upon which the apparatus 100 will be placed, the vertical member 110 may be extendable and collapsible through the multiple (e.g., hollow) sections being extended or collapsed according to dimensions of the fixture. A mechanism for releasing the sections to be moved relative to each other (e.g., either to extend or to reduce a length of the vertical member) and/or to lock the sections in place may be included in the vertical member 110. The length of the vertical member 110 may also be reduced to a minimum size by collapsing the multiple sections for compact storage of the apparatus 100 when not in use.

As in the illustrated embodiment of FIG. 1, the second arm 130 extends from the vertical member 110 further than the first arm 120. The second arm 130 is considered to be longer than the first arm 120. Alternatively, the first arm 120 may be longer than the second arm 130.

The first arm 120 includes the light source 150 providing a readily available light source for use in easily reading items such as menus, a check, etc., in dimly lit or darkened areas, such as restaurants, cinemas, theatres, etc., and as well as locating items such as car keys, a cosmetic or other personal items within the purse or handbag.

The light source 150 may include a power supply 152 and a light generating part 154. The power supply 152 may include, but is not limited to, a crystal battery, a button cell battery, a rechargeable battery, a disposable battery (e.g., “AAA” or “AA” sized battery) and a solar cell. The power supply 152 may be contained within the first arm 120 or may be disposed on an external area of the first arm 120 (e.g., a solar cell may be built into the apparatus 100, such as being exposed to an outside of the apparatus 100).

The light generating part 154 may include, but is not limited to, a light-emitting diode (“LED”), a Xenon light source and a microlight. While a single light generating part 154 is illustrated in FIG. 1, the invention is not limited thereto. The apparatus 100 may include more than one light generating part 154 of the same or varying types.

The first arm 120 may include a first cap 140 attached to a distal end of the first arm 120. The first cap 140 may be detachable from the first arm 120 by a snap, twist or screw mechanism. The first cap 140 may include the light generating part 154 (e.g., a bulb), such as inside the twist mechanism, or may secure the light source 150 within the first arm 120.

In an exemplary embodiment, the first cap 140 may serve as the actuating mechanism of the light source 150, such as by turning the first cap 140 clockwise or counterclockwise. Alternatively, a switch or toggle for operating the light source 150 may be disposed on the apparatus 100, such as where it is convenient to operate the light source 150 while using or holding the apparatus 100.

The first arm 120 may be pivotable along an axis of the vertical member 110 to position the light source 150 in a desired location. The first arm 120 and/or the light source 150 may be pivotable while the personal article is being held by the apparatus 100, such that the personal article does not have to be removed to pivot the light source 150. Alternatively, the personal article could be removed from the apparatus 100 to use and pivot the light source 150:

The first arm 120 may also be pivoted along the axis of the vertical member 110 to extend the first arm 120 in a direction opposite to the second arm 130 relative to the vertical member 110. When the first arm 120 and the second arm 130 are extended in opposing directions, the apparatus 100 may be used such that the first arm 120 is able to be rested on an upper surface of a door or door frame while the second arm 130 could be used to hang a personal article such as a coat when there is no convenient place to store such an item.

The first arm 120 may include a friction or gripping part (not shown) to improve the stability of the apparatus 100 in contacting the upper surface of the fixture and to reduce or prevent slipping or moving of the apparatus 100. A clamp or other securing-type member may be included in the apparatus 100 to secure the apparatus 100 to the underside of the fixture such that movement of the apparatus 100 from a set position on the fixture is reduced or effectively prevented.

The second arm 130 may include a second cap 142 attached to a distal end of the second arm 130. The second cap 142 may be detachable from the second arm 130 by a snap, twist or screw mechanism. The second cap 142 serves to secure a personal item 170 contained in the second arm 130, such as money, keys, lipstick/gloss, a whistle, pepper spray, toothpicks, candy or gum and the like. In exemplary embodiments, utility items may be integrated into the second cap 142, such as a magnifying glass or a lighter.

The apparatus 100 may include an alarm that is activated in response to movement detected with respect to the apparatus 100 and provide an audible and/or visual alert. The movement activating the alarm may include, but is not limited to, removal of the personal article from the lower arm, removal of the personal items from the storage space and/or removal of the apparatus from the fixture. The alarm may be pressure activated for automatic activation or may be manually activated by a switch or part on the apparatus 100. In one exemplary embodiment, the audible alert may be generated from an alarm unit 180 (See FIG. 2) positioned along an exterior of the apparatus 100. The visual alert may include a light (not shown) that blinks or pulses to notify a user. The light source 154 may be actuated as the visual alert. In an exemplary embodiment, the audible and/or visual alert may be activated individually or both the audible and visual alert may be activated at substantially the same time to notify the user of the personal article (or apparatus) being moved or removed.

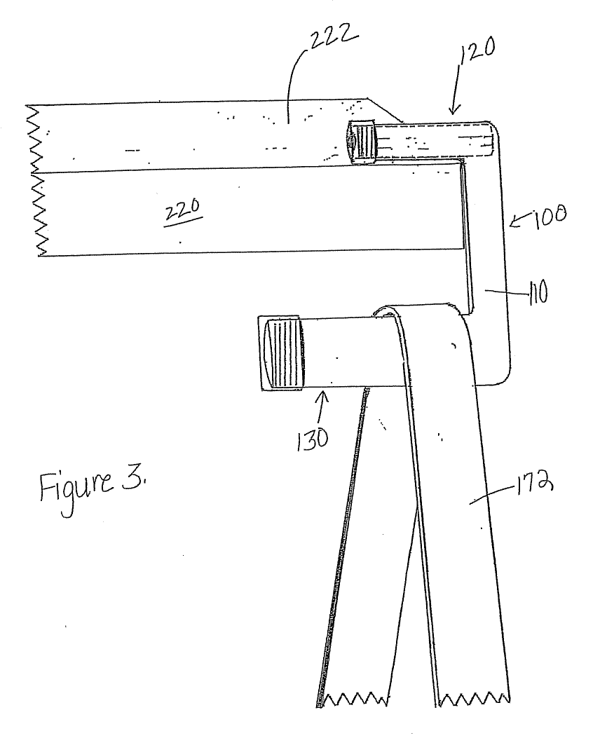

FIG. 3 illustrates an exemplary embodiment of the apparatus 100 being used to suspend a personal article from a fixture.

The personal article 172 may be handbag, purse, shopping bag, hat, etc. A strap or handle of the personal article 172 is placed over the second arm 130. The first arm 120 is positioned on an upper surface 222 of a fixture 220, such as a table or counter top. The weight of the personal article 172 holds the strap in contact with the lower arm 130 and the upper arm 120 in contact with the upper surface 222 of the fixture 220. The lower arm 130 may include a treatment, covering, texturing or gripping part to improve the stability of the personal article 172 on the second arm 130.

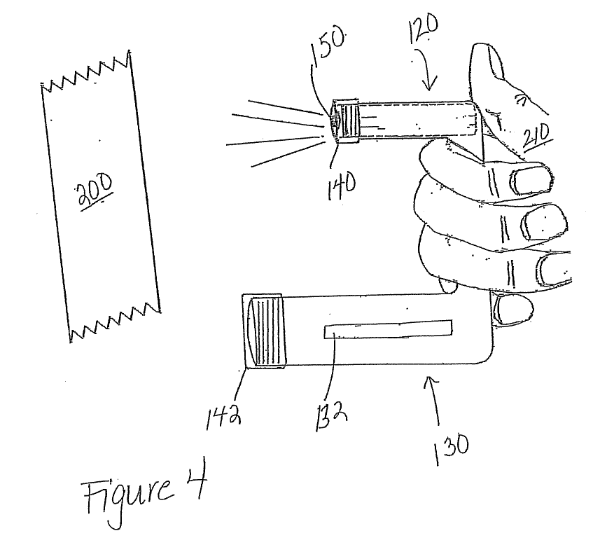

FIG. 4 illustrates an exemplary embodiment of the apparatus 100 being used to view an object.

A user 210 may desire to view or read an object 200, such as a menu, a bill, a car door lock, mail box or the like in a dimly lit or dark place. The user 210 activates the light source 150 on the first arm 120 of the apparatus 100, such as by rotating the first cap 140. As illustrated in FIG. 4, the apparatus 100 may be removed from the fixture 220 to utilize the light source 150 to view the object 200. Alternatively, the light source 150 may be activated and used to view the object 200 while the apparatus remains resting on the fixture 220. The user 210 holds the apparatus 100 by the vertical member 110 to direct the light towards the object 200.

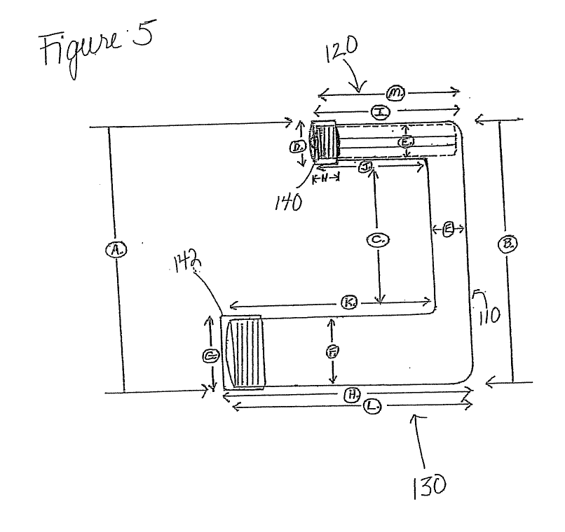

FIG. 5 is an exemplary embodiment showing dimensions of the apparatus. A length (A) from an outer upper surface of the first cap 140 to an outer lower surface of the second cap 142 may be approximately 3.75″ (inches). A length of the vertical member 110 from an end (or outer surface) of the top arm 120 to an end (or outer surface) of the bottom arm 130 (B), also considered as a “height” of the apparatus, may range from about 3″ to about 6″. An inside distance from an inner surface of the top arm 120 to an inner surface of the bottom arm 130 (C) may be approximately 2 3/16″.

An outer diameter (D) of the first cap 140 may be about ⅝″. The screw mechanism on the top arm 120 may include a 1/16″ interior thread. The first cap 140 may be about ⅜″ in depth (or length) (N) from a distal end of the first cap 140. An outer diameter (G) of the second cap 142 may be about 1⅛″.

A width (or diameter) (E) of the top arm 120 and the vertical member 110 may range from about ⅜″ to about 1.25″. A width (or diameter) (F) of the bottom arm 130 including the utility space 160 may range from about ⅜″ to about 1.25″.

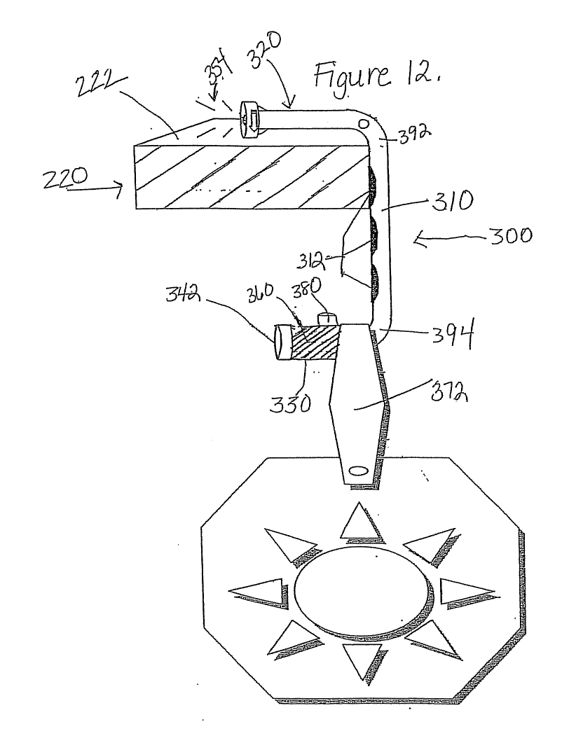

In exemplary embodiments, the top arm 120 and the bottom arm 130 may include substantially the same diameter as shown in the embodiments of FIGS. 11, 13 and 14. Alternatively, the diameters of the top arm 120 and the bottom arm 130 may be different from each other as illustrated in FIGS. 1 and 2. While the diameters of the top arm 120 and the bottom arm 130 are illustrated with a substantially constant diameter from an end proximate to the vertical member 110 to the distal end, respectively, the invention is not limited thereto. In an exemplary embodiment, the diameter of the top arm 120 and/or the bottom arm 130 may be tapered in a longitudinal direction of the top arm 120 and the bottom arm 130, respectively.

A compartment housing the power supply 152 (See FIGS. 1 and 2) may be inserted into the top arm 120. The compartment may be approximately 1⅞″ in length (taken along a longitudinal direction of the top arm 120) and approximately 7/16″ in diameter (taken in a direction substantially perpendicular to the longitudinal direction of the top arm 120).

A length (H) from a distal end of the second cap 142 to an outer edge of the vertical member 110 may be approximately 3½″. A length (K) from a inside of the vertical member 110 to the distal end of the bottom arm 130 may be about 2⅞″. A length (L) from the outside of the vertical member 110 to the distal end of the bottom arm 130 may be about 3⅜″.

A length (I) from a distal end of the first cap 140 to an outer edge of the vertical member 110 may be approximately 2⅛″. A length (J) from the inside of the vertical member 110 to the distal end of the top arm 120 may be about ½″. A length (M) from the outside of the vertical member 110 to the distal end of the top arm 120 may be about 2.0″.

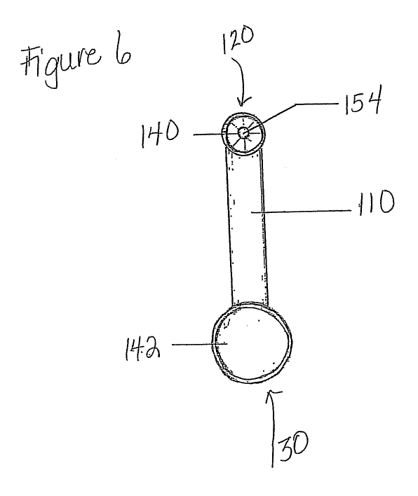

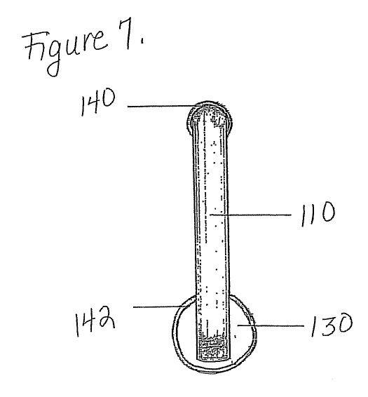

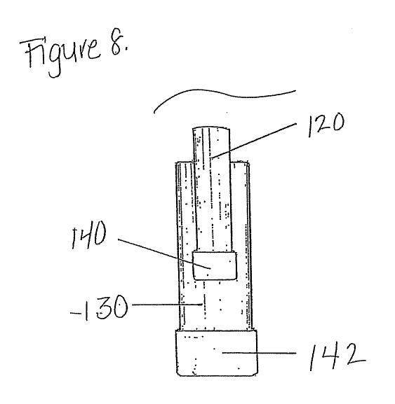

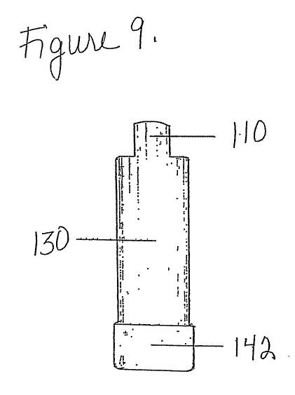

FIGS. 6-9 illustrate front, back, top and bottom views, respectively of the apparatus 100.

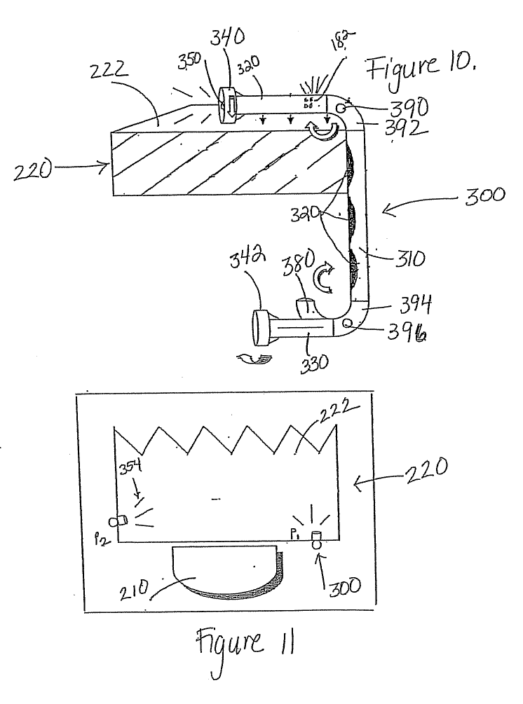

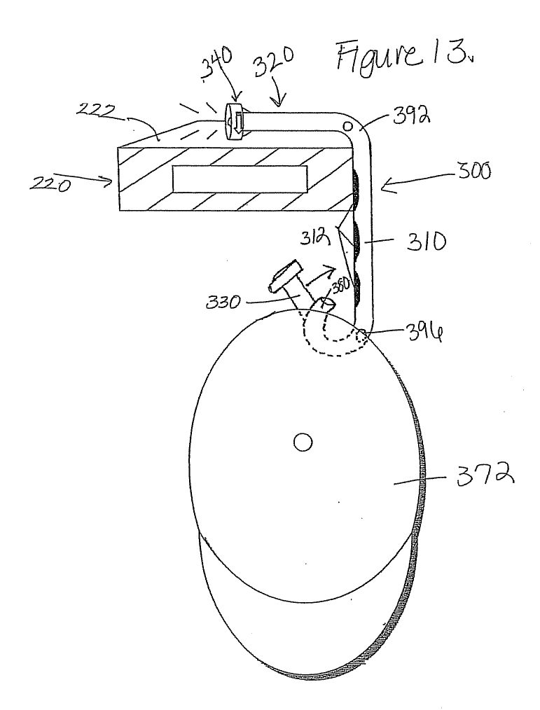

FIG. 10 is a side view of another exemplary embodiment of an apparatus according to the present invention. FIG. 11 is a top view of the apparatus being used to direct light to a desired position. FIG. 12 is a side view of another exemplary embodiment of an apparatus according the present invention holding a personal article.

The apparatus 300 includes a vertical length 310, an upper arm 320 extending substantially horizontally from an upper end of the vertical length 310 and a lower arm 330 extending substantially horizontally from a lower end of the vertical length 310. The upper arm 120 is rested on upper surface 222 of a fixture 220, such as a table, counter, etc. A personal article would be suspended or hung on the lower arm 330.

As illustrated in FIG. 10, the lower arm 330 includes a straight portion and a hook-like portion 380 from which a personal article 372, such as a handbag, may hang. The lower arm 330 includes a utility space 360 within the straight portion of lower arm 330 for storing a personal item. Alternatively, the lower arm 330 may be angled in an upward direction towards the upper arm 320.

The upper arm 320 extends from the vertical length 310 further than the lower arm 330. The second arm 330 is considered to be shorter than the upper arm 120. Alternatively, the lower arm 330 may be longer than the upper arm 320.

The apparatus 300 is substantially “C” or “U” shaped and may be configured as a single continuous unit. The vertical length 310, the upper arm 320 and/or the lower arm 330 may be solid or hollow.

The upper arm 320 and the lower arm 330 may be pivotable such that they fold towards the vertical length 310 and unfold to a substantially horizontal position. The upper arm 320 is pivotable at a transition portion 392 between the upper arm 320 and the vertical length 310. Similarly, the lower arm 330 is pivotable at a transition portion 394 between the lower arm 330 and the vertical length 310. The transition portions 392 and 394 may include a hinge 390 and 396, respectively, providing the upper arm 320 and the lower arm 330 with a pivoting mechanism.

The upper arm 320 includes the light source 350 providing a readily available light source for use in easily reading items such as menus, a check, etc., in dimly lit or darkened areas, such as restaurants, cinemas, theatres, etc., and as well as locating items such as car keys, a cosmetic or other personal items within the purse or handbag. The light source 150 may include a power supply and a light generating part.

In an exemplary embodiment, the first cover 340 may serve as the actuating mechanism of the light source 350, such as by turning the first cover 340 clockwise or counterclockwise as indicated by the arrow in FIG. 10. The second arm 330 may include a second cover 342 attached to a distal end of the lower arm 330. The second cover 342 may be detachable from the lower arm 330 by a snap, twist or screw mechanism.

The light source 350 may be activated and used to view an object while the apparatus 300 remains resting on the fixture 220. As illustrated in FIG. 11, the apparatus 300 remains resting on the fixture 220 and light 354 is directed to a desired position by rotating the apparatus 300. At position P₁ the apparatus may be providing light 354 in a direction substantially perpendicular to an edge of the fixture 220 (e.g., a table) where a user 210 may be seated. The apparatus 300 may be rotated from a perpendicular position to a rotated position, such as shown by the apparatus at position P₂ on another edge of the fixture 220. Advantageously, the personal article remains conveniently out of the way of the user while light is made available at the upper surface 222 of the fixture 220.

As illustrated in FIGS. 10 and 12, the vertical length 310 may include holding (or gripping) parts 312. The holding parts 312 may include areas that are smoothed, molded, carved, covered, textured or the like to allow fingers of a user to hold onto or grip the apparatus 300. The holding parts 312 may be formed by altering the exterior of the vertical length 310 or by disposing a separate piece on the exterior of the vertical length (e.g., adhering a rubber-like pad or a sleeve).

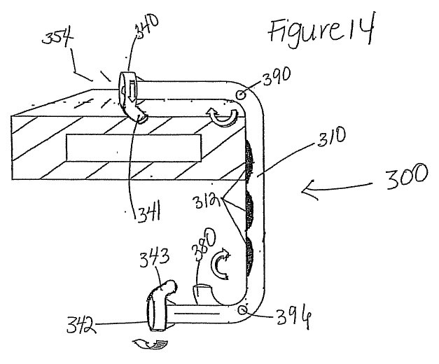

FIG. 13 is a side view of another exemplary embodiment of an apparatus according to the present invention including an angled lower arm holding a personal article. The personal article 372 is suspended from the hook-like portion 380 of the lower arm 330. The lower arm 330 is angled upwards toward the upper arm 320. The pivot point (or hinge) 396 may lock so as to allow the lower arm 330 to hold its angled position under the weight of the personal article 372. In an alternative embodiment, the lower arm 330 may include only a straight portion (without the hook-like portion 380) being angled towards the upper arm 320.

FIG. 14 is a side view of another exemplary embodiment of an apparatus according to the present invention including a protruding portion on the first and second covers. The first cover 340 and the second cover 342 may include protruding portions 341 and 343, respectively. If the apparatus 300 is turned and held such that the vertical length 310 is substantially horizontal, the inward extending protruding portions 341 and 343 may be used to hold handles of a personal article, such as a shopping bag. When such a bag includes thin handles and when the contents of the bag is relatively heavy, carrying the shopping bag by the thin handles may be uncomfortable or painful in a hand of the user. By hanging the handles on the protruding portions 341 and 343, the user may carry the shopping bag by the vertical length 310 in a more comfortable manner.

The apparatus 300 may include an alarm activated in response to movement detected with respect to the apparatus 100 and provide an audible and/or visual alert. The movement activating the alarm may include, but is not limited to, removal of the personal article from the lower arm, removal of the personal items from the storage space and/or removal of the apparatus from the fixture 220. The alarm may be pressure activated for automatic activation or may be manually activated by a switch or part on the apparatus 300. The audible alert may be generated from an alarm unit positioned along an exterior of the apparatus 300. The visual alert may include a light source 182 (See FIG. 10) that blinks or pulses to notify the user. As an additional safety feature, an emergency or “panic button” (e.g., an audible alarm) may also be included in the apparatus enabling a user to call help if needed.

In exemplary embodiments, the apparatus may be constructed of aluminum, iron, metals, plastic or other materials such that the apparatus is relatively light weight to the user but having a strength so as to not substantially deform under a weight of the personal article hanging from the lower arm while the upper arm rests on an upper surface of a table, counter, etc.

The apparatus may include any of a number of colors, textures and finishes as it suitable for its purpose. In exemplary embodiments, the apparatus may be used for advertising or other promotional purposes. In one exemplary embodiment, the apparatus may include a flattened or planar area (See FIG. 4, 132) such that a logo, message, identification or other information can be placed thereon. The information may be placed on the planar area through any of a number of methods, such as etching, engraving, printing or the like. The planar area may be located at any of the vertical length, the lower arm and/or the upper arm.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An apparatus for holding a personal article, comprising:
a vertical member;
a first arm extending from a first end of the vertical member and resting on an upper surface of a fixture; and
a second arm extending from a second end of the vertical member from which the personal article hangs;
wherein the first arm includes a light source; and
wherein the second arm includes a utility space storing personal items.

2. The apparatus of claim 1, wherein the first arm extends from the vertical member further than the second arm extends from the vertical member.

3. The apparatus of claim 1, wherein the second arm extends from the vertical member further than the first arm extends from the vertical member.

4. The apparatus of claim 1, further comprising an alarm activated in response to movement detected with respect to the apparatus, the movement including at least one of:
removal of the personal article from the second arm;
removal of the personal items from the utility space in the second arm; and
removal of the apparatus from the fixture.

5. The apparatus of claim 1, wherein the second arm is angled in an upward direction towards the first arm.

6. The apparatus of claim 1, wherein the second arm includes a hook-like member from which the personal article hangs.

7. The apparatus of claim 1, wherein the first arm includes a first cap disposed over a distal end of the first arm, the first cap actuating the light source “on” and “off”, and the second arm includes a second cap disposed over a distal end of the second arm, the second cap securing the personal items in the utility space.

8. The apparatus of claim 1, wherein the light source includes one of a crystal battery, a button cell battery, a rechargeable battery, a disposable battery, a light-emitting diode (“LED”), a Xenon light source, a microlight and a combination including at least one of the foregoing.

9. The apparatus of claim 1, wherein the first arm is pivotable at a transition portion between the first arm and the vertical member such that the light source is pivotable for selective positioning while the personal article is hanging from the second arm.

10. The apparatus of claim 1, wherein the first arm and the second arm are pivotable at a transition portion between the first arm and the vertical member and the second arm and the vertical member, respectively, such that the first arm and the second arm fold toward the vertical member.

11. The apparatus of claim 1, wherein the vertical member includes one of texturing, indented portions, finger spaces and a combination including at least one of the foregoing.

12. The apparatus of claim 1, wherein one of the vertical member, the first arm, the second arm and a combination including one of the foregoing includes a planar area on an exterior surface.

13. The apparatus of claim 1, wherein the vertical member includes multiple sections configured to be slidably connected relative to each other such that a length of the vertical member can be expanded and contracted by sliding the multiple sections relative to each other.

14. An apparatus for holding a personal article, comprising:
a vertical member;
a first member extending substantially horizontally from the vertical member and resting on a top surface of a fixture; and
a second member extending substantially horizontally from the vertical member and from which the personal article hangs, the second member being longer than the first member;
wherein the first member includes a light generating part; and
wherein the second member includes a storage space in which personal items are stored.

15. The apparatus of claim 14, further comprising an alarm activated in response to movement detected with respect to the apparatus, the movement including at least one of:
removal of the personal article from the second member;
removal of the personal items from the storage space; and
removal of the apparatus from the fixture.

16. An apparatus for holding a personal article, comprising:
a vertical member;
an upper arm extending substantially horizontally from the vertical member and resting on an upper surface of a fixture, the upper arm including a light generating part;
a lower arm extending substantially horizontally from the vertical member and from which the personal article hangs, the lower arm being longer than the upper arm and including a storage space in which personal items are stored; and
an alarm activated in response to movement detected with respect to the apparatus, the movement including at least one of:
removal of the personal article from the lower arm;
removal of the personal items from the storage space; and
removal of the apparatus from the fixture.
